(19) United States
(12) Patent Application Publication
(10) Pub. No.: US 2019/0060703 A1
(43) Pub. Date: Feb. 28, 2019

(54) Yoga Towel and Method for Making the Same

(71) Applicant: Meng Chieh Lin, Fengyuan Dist. (TW)

(72) Inventor: Meng Chieh Lin, Fengyuan Dist. (TW)

(21) Appl. No.: 16/108,205

(22) Filed: Aug. 22, 2018

(30) Foreign Application Priority Data
Aug. 23, 2017 (TW) 106128513

(51) Int. Cl. A63B 21/00; B29C 51/10; B29C 51/14

(52) U.S. Cl. CPC A63B 21/4037; B29C 51/36; B29C 51/14; B29C 51/10

(57) ABSTRACT

A method for making a yoga towel includes a step of preparing a towel with multiple apertures defined therethrough, a resilient plate placed on the towel; a step of placing the towel and the resilient plate between a top mold and a bottom mold which has cavities defined therethrough; a step of heating and softening the resilient plate and matching the top mold to the bottom mold, and a step of vacuuming to suck the softened resilient plate to form anti-slip protrusions on the second face of the towel via the apertures. The anti-slip protrusions are integrally formed with the towel and have elasticity.

### BACKGROUND OF THE INVENTION

### 1. Fields of the Invention

The present invention relates to a yoga towel, and more particularly, to a yoga towel with anti-slip protrusions and a resilient member, and to a method for making the yoga towel.

### 2. Descriptions of Related Art

The conventional yoga pad generally is made by a foam pad with a certain thickness and the yoga pad provides anti-slip feature so that the yoga pad does not slip when being used. The yoga pad has a yoga towel attached to the top surface thereof and allows the users on the yoga towel to smoothly move. Also the yoga towel provides proper anti-slip feature to position the users on the yoga towel.

The conventional yoga towel is made of cotton yarns and multiple anti-slip protrusions are formed on the yoga towel by way of screen printing.

However, the protrusions formed on the yoga towel only have a height of 0.5 mm due to restrictions of the nature of screen printing. The yoga towel tends to be deformed due to stretching, and the protrusions become shorter when the yoga towel is stretched. This cause less friction and the uses may slip on the yoga towel.

Besides, the protrusions formed by way of screen printing actually are made of ink which can be easily peeled off from the cotton yarns and therefore cannot provide the desired friction.

The present invention is intended to provide a yoga towel and a method for making the yoga towel to eliminate the drawbacks mentioned above.

### SUMMARY OF THE INVENTION

The present invention relates to a method for making a yoga towel, and comprises:

a step of components preparing: preparing a first towel and at least one resilient plate, the first towel having a first face and a second face which is located opposite to the first face, multiple apertures located in communication between the first and second faces, the at least one resilient plate located on the first face of the first towel;

a step of mold set preparing: preparing a top mold and a bottom mold, the first towel and the at least one resilient plate located between the top and bottom molds, the at least one resilient plate located between the first face of the first towel and the top mold, the second face of the first towel located in the bottom mold, the bottom mold having multiple cavities defined therethrough, a vacuum device located corresponding to the cavities of the bottom mold;

a step of heating: preparing a temperature control device to heat the at least one resilient plate to soften the at least one resilient plate on the first face of the first towel, matching the top mold with the bottom mold, and

a step of vacuuming: vacuuming the cavities of the bottom mold by the vacuum device to suck the at least one resilient plate into the cavities of the bottom mold via the apertures so as to form multiple anti-slip protrusions on the second face of the first towel.

The yoga towel of the present invention comprises a towel having a first face and a second face which is located opposite to the first face. Multiple apertures are located in communication between the first and second faces. A resilient plate is located on the first face of the first towel. The second face of the towel has multiple anti-slip protrusions formed thereon. The anti-slip protrusions are formed by sucking softened resilient plate via the apertures.

The advantages of the present invention are that the anti-slip protrusions are integrally formed with the towel and are not peeled off from the yoga towel.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the steps of the method of the present invention;

FIG. 2 shows that the first towel and the resilient plate are located between the top mold and the bottom mold;

FIG. 3 shows that the top mold is matched with the bottom mold with the first towel and the resilient plate located between the top and bottom molds;

FIG. 4 shows another method of the present invention, wherein the first towel, the second towel and the resilient plate are located between the top mold and the bottom mold;

FIG. 5 is a perspective view to show the yoga towel of the present invention;

FIG. 6 is a cross sectional view of the yoga towel of the present invention made by method disclosed in FIG. 1, and

FIG. 7 shows a cross sectional view of the yoga towel of the present invention made by method disclosed in FIG. 4.

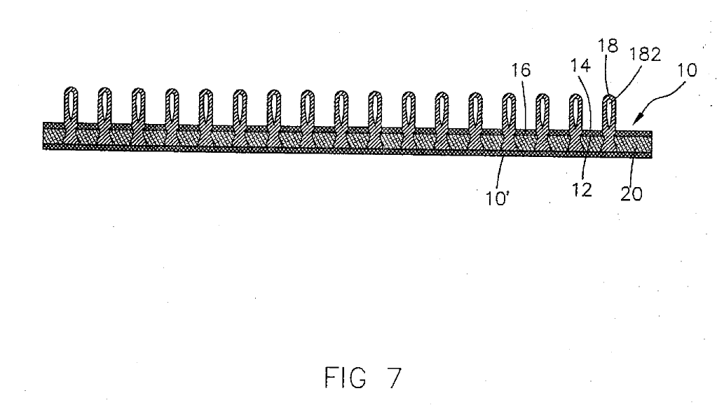

### DETAILED DESCRIPTION OF THE PREFERRED EMBODIMENT

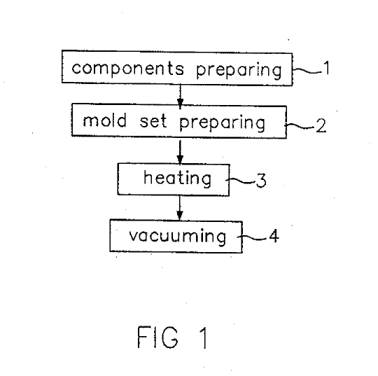

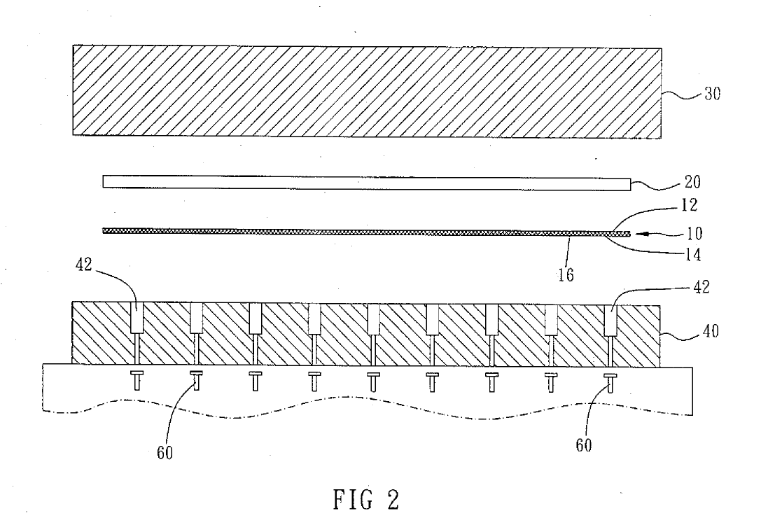

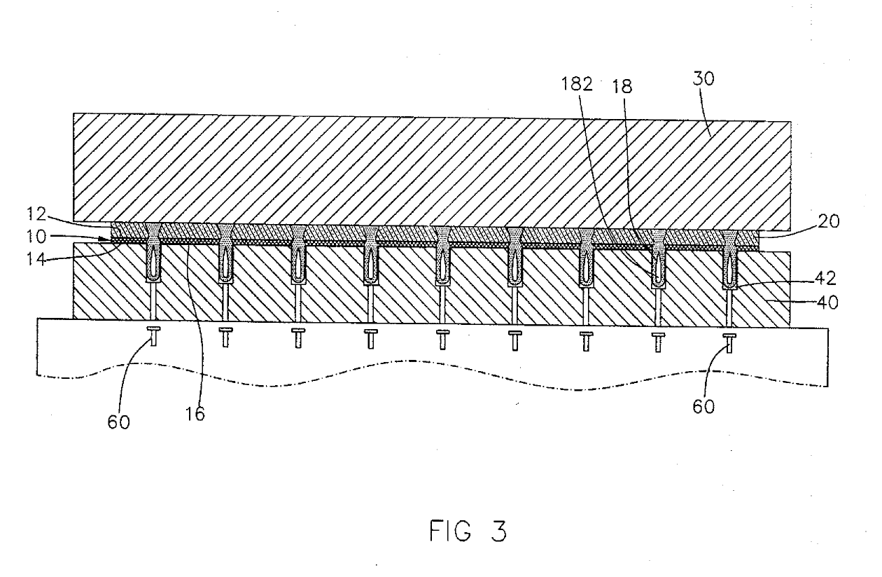

Referring to FIGS. 1 to 3, the first method of the present invention to make a yoga towel comprises the following steps:

a step of components preparing 1: preparing a first towel 10 and at least one resilient plate 20, the first towel 10 having a first face 12 and a second face 14 which is located opposite to the first face 12, multiple apertures 16 located in communication between the first and second faces 12, 14, the at least one resilient plate 20 located on the first face 12 of the first towel 10;

a step of mold set preparing 2: preparing a top mold 30 and a bottom mold 40, the first towel 10 and the at least one resilient plate 20 located between the top and bottom molds 30, 40, the at least one resilient plate 20 located between the first face 12 of the first towel 10 and the top mold 30, the second face 14 of the first towel 10 located in the bottom mold 40, the bottom mold 40 having multiple cavities 42 defined therethrough, a vacuum device 60 located corresponding to the cavities 42 of the bottom mold 40;

a step of heating 3: preparing a temperature control device (not shown) to heat the at least one resilient plate 20 to soften the at least one resilient plate 20 on the first face 12 of the first towel 10, matching the top mold 30 with the bottom mold 40, and

a step of vacuuming: vacuuming the cavities 42 of the bottom mold 40 by the vacuum device 60 to suck the at least one resilient plate 20 into the cavities 42 of the bottom mold 40 via the apertures 16 so as to form multiple anti-slip protrusions 18 on the second face 14 of the first towel 10.

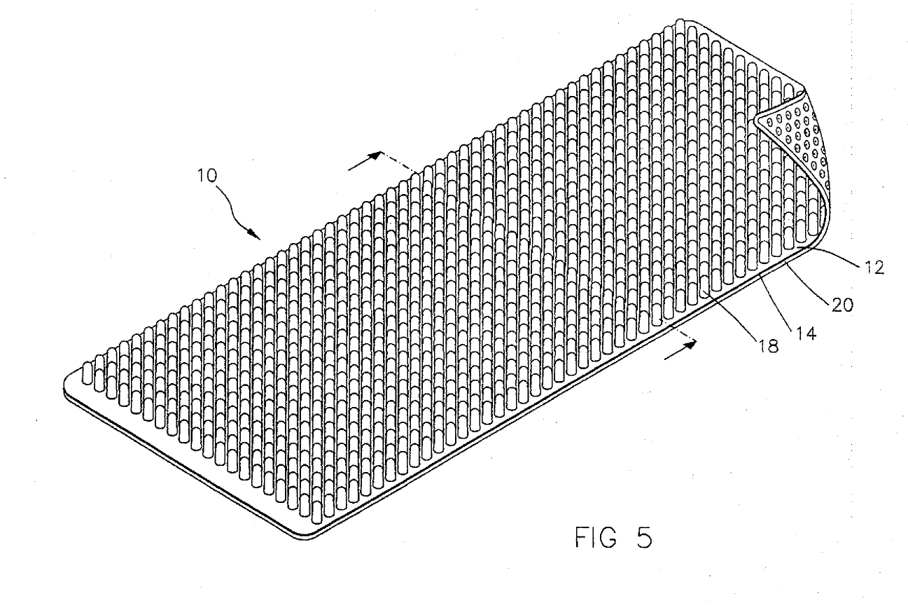

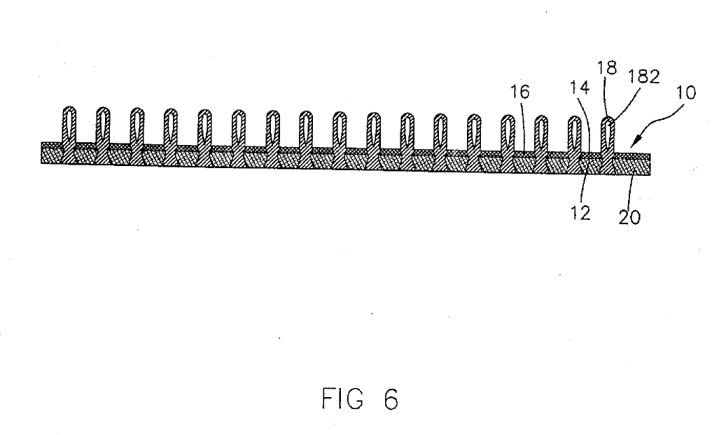

The yoga towel made by the method of the present invention is disclosed in FIGS. 5 and 6, and comprises a towel 10 having a first face 12 and a second face 14 which is located opposite to the first face 12. Multiple apertures 16 are located in communication between the first and second faces 12, 14. A resilient plate 20 is located on the first face 12 of the first towel 10. The second face 14 of the towel 10 has multiple anti-slip protrusions 14 formed thereon. The anti-slip protrusions 14 are formed by sucking softened resilient plate 20 via the apertures 16. Preferably, the anti-slip protrusions 18 are cylindrical protrusions and the height of each of the anti-slip protrusions 18 is between 0.5 mm to 20 mm beyond the second face 14. The anti-slip protrusions 18 protrude from the second face 14 of the first towel 10 and are resilient so as to provide proper friction to the users.

Specifically, the towel 10 is made of cotton or fabric, and there are multiple apertures 16 defined through the towel 10. When the resilient plate 20 is softened, the softened resilient material of the resilient plate 20 is sucked by the vacuum force so that it flows through the apertures 16 and is integrally formed with the towel 10. The size of the resilient plate 20 is preferably the same as that of the towel 10, and the number of the resilient plate 20 can be added as desired.

Because the anti-slip protrusions 18 are integrally formed with the first towel 10, and protrude beyond the second face 14 of the first towel 10 via the apertures 16, so that the anti-slip protrusions 18 are not peeled off from the first towel 10.

Alternatively, it is noted that because the anti-slip protrusions 18 are formed by suction force and the suction force will suck the softened resilient material and forms each of the anti-slip protrusions 18 to have a room 182 defined therein, and air is accommodated in the room 182.

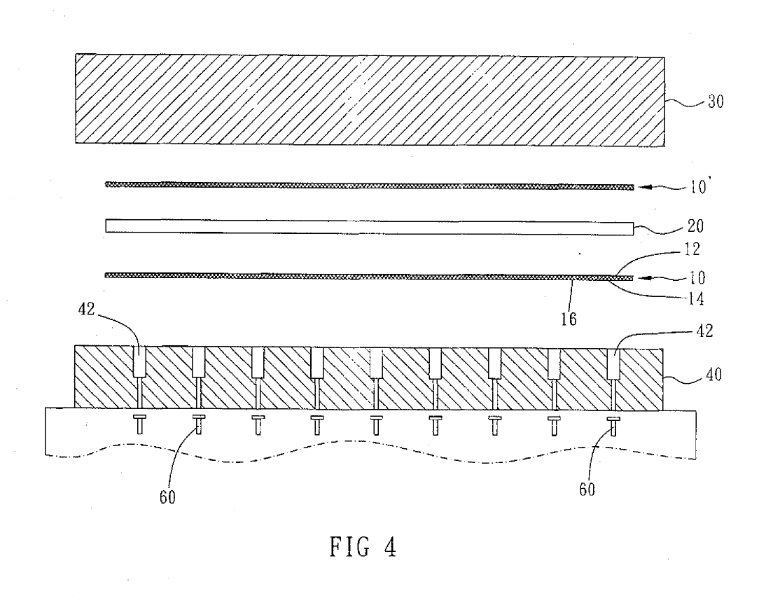

As shown in FIG. 4, in the step of components preparing 1, a second towel 10′ is placed between the at least one resilient plate 20 and the top mold 30. The first face 12 of the first towel 10 is matched with the second towel 10′, and the second face 14 of the first towel 10 has the multiple anti-slip protrusions 18 formed thereon.

While we have shown and described the embodiment in accordance with the present invention, it should be clear to those skilled in the art that further embodiments may be made without departing from the scope of the present invention.

What is claimed is:

1. A method for making a yoga towel, comprising:
a step of components preparing: preparing a first towel and at least one resilient plate, the first towel having a first face and a second face which is located opposite to the first face, multiple apertures located in communication between the first and second faces, the at least one resilient plate located on the first face of the first towel;
a step of mold set preparing: preparing a top mold and a bottom mold, the first towel and the at least one resilient plate located between the top and bottom molds, the at least one resilient plate located between the first face of the first towel and the top mold, the second face of the first towel located in the bottom mold, the bottom mold having multiple cavities defined therethrough, a vacuum device located corresponding to the cavities of the bottom mold;
a step of heating: preparing a temperature control device to heat the at least one resilient plate to soften the at least one resilient plate on the first face of the first towel, matching the top mold with the bottom mold, and
a step of vacuuming: vacuuming the cavities of the bottom mold by the vacuum device to suck the at least one resilient plate into the cavities of the bottom mold via the apertures so as to form multiple anti-slip protrusions on the second face of the first towel.

2. The method as claimed in claim 1, wherein a second towel is placed between the at least one resilient plate and the top mold in the step of components preparing, the first face of the first towel is matched with the second towel, the second face of the first towel has the multiple anti-slip protrusions formed thereon.

3. A yoga towel comprising:
a towel having a first face and a second face which is located opposite to the first face, multiple apertures located in communication between the first and second faces, a resilient plate located on the first face of the first towel, the second face of the towel having multiple anti-slip protrusions formed thereon, the anti-slip protrusions being formed by sucking softened resilient plate via the apertures.

4. The yoga towel as claimed in claim 3, wherein the anti-slip protrusions are cylindrical protrusions.

5. The yoga towel as claimed in claim 4, wherein a height of each of the anti-slip protrusions is between 0.5 mm to 20 mm.

6. The yoga towel as claimed in claim 4, wherein each of the anti-slip protrusions has a room defined therein.

7. The yoga towel as claimed in claim 5, wherein each of the anti-slip protrusions has a room defined therein.

8. The yoga towel as claimed in claim 6, wherein each of the anti-slip protrusions has air received in the room.

9. The yoga towel as claimed in claim 7, wherein each of the anti-slip protrusions has air received therein.

10. The yoga towel as claimed in claim 3 further comprising a second towel and the second towel is attached to a top of the resilient plate.
